(19) United States
(12) Patent Application Publication
(10) Pub. No.: US 2010/0056477 A1
(43) Pub. Date: Mar. 4, 2010

(54) FUNGICIDAL MIXTURES OF AMIDINYLPHENYL COMPOUNDS

(75) Inventors: Ulrike Wachendorff-Neumann, Neuwied (DE); Peter Dahmen, Neuss (DE); Ralf Dunkel, Lyon (FR); Herbert Gayer, Monheim (DE); Klaus Kunz, Dusseldorf (DE); Ahmed Wahed Moradi, Monheim (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim (DE)

(21) Appl. No.: 12/515,410

(22) PCT Filed: Nov. 16, 2007
(86) PCT No.: PCT/EP2007/009904

§ 371 Date: May 19, 2009

(30) Foreign Application Priority Data
Nov. 28, 2006 (EP) 06024578.4

(51) Int. Cl. A01N 55/10; A01P 3/00

(52) U.S. Cl. 514/63

(57) ABSTRACT

This invention relates to fungicidal mixtures of certain phenylamidines, their N-oxides, and/or agriculturally suitable salts thereof, and to compositions comprising such mixtures and methods for using such mixtures as fungicides.

This invention relates to fungicidal mixtures of certain phenylamidines, their N-oxides, and/or agriculturally suitable salts thereof, and to compositions comprising such mixtures and methods for using such mixtures as fungicides.

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new mixtures and compositions that are more effective, less costly, less toxic and environmentally safer or have different modes of action.

Fungicides that effectively control plant fungi are in constant demand by growers.

Combinations of fungicides are often used to facilitate disease control and to retard resistance development. It is desirable to enhance the activity spectrum and the efficacy of disease control by using mixtures of active ingredients that provide a combination of curative, systemic and preventative control of plant pathogens. Also desirable are combinations that provide greater residual control to allow for extended spray intervals. It is also very desirable to combine fungicidal agents that inhibit different biochemical pathways in the fungal pathogens to retard development of resistance to any one particular plant disease control agent.

Being able to reduce the quantity of chemical agents released in the environment while ensuring effective protection of crops from diseases caused by plant pathogens is always desirable. Mixtures of fungicides may provide significantly better disease control than could be predicted based on the activity of the individual components. This synergism has been described as “the cooperative action of two components of a mixture, such that the total effect is greater or more prolonged than the sum of the effects of the two (or more) taken independently” (see P. M. L. Tames, Neth. J. Plant Pathology 1964, 70, 73-80).

New fungicidal agents that are particularly advantageous in achieving one or more of the preceding objectives continue to be needed.

WO 2003/093224 discloses certain phenylamidines of Formula i as new fungicidal active ingredients.

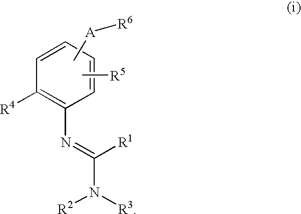

WO 2005/120234 discloses fungicidal mixtures, compositions and methods for controlling plant diseases relating to combinations comprising (a) at least one compound selected from phenylamidines of Formula I, N-oxides, and agriculturally suitable salts thereof (I) wherein A is C₃alkylene, optionally substituted with one or two methyl; W is CR⁵R⁶R⁷ or SiR⁸R⁹R¹⁰; and R¹, R², R³, R⁴, R⁵, R⁶, R⁷, R⁸, R⁹ and R¹⁰ are as defined in the disclosure; and (b) at least one compound selected from alkylenebis(dithiocarbamate) fungicides, compounds acting at the bc1 complex of the fungal mitochondrial respiratory electron transfer site, cymoxanil, compounds acting at the demethylase enzyme of the sterol biosynthesis pathway, morpholine and piperidine compounds that act on the sterol biosynthesis pathway, phenylamide fungicides, pyrimidinone fungicides, chlorothalonil, carboxamides acting at complex II of the fungal mitochondrial respiratory electron transfer site, quinoxyfen, metrafenone, cyflufenamid, cyprodinil, copper compounds, phthalimide fungicides, fosetyl-aluminum, benzimidazole fungicides, cyazofamid, fluazinam, iprovalicarb, propamocarb, validamycin, dichlorophenyl dicarboximide fungicides, zoxamide and dimethomorph, and their agriculturally suitable salts.

The activity of these mixtures is good; however, at low application rates it is sometimes unsatisfactory.

We have now found novel active compound combinations having very good fungicidal properties comprising:
(a) at least one compound selected from the phenylamidines of Formula I, N-oxides, and agriculturally suitable salts thereof

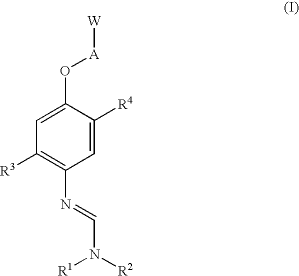

wherein
R¹ is C₁-C₂ alkyl;
R² is C₁-C₃ alkyl or cyclopropyl;
R³ is hydrogen, C₁-C₂ alkyl or halogen;
R⁴ is C₁-C₂ alkyl, C₁-C₂ haloalkyl, methoxy, halomethoxy, C₁-C₂ alkylthio, C₁-C₂ alkylsulfinyl, C₁-C₂ alkylsulfonyl or halogen;
A is C₃ alkylene, optionally substituted with one or two methyl;
W is CR⁵R⁶R⁷ or SiR⁸R⁹R¹⁰; and
R⁵ is hydrogen or C₁-C₃ alkyl optionally substituted with halogen; and each R⁶, R⁷, R⁸, R⁹ and R¹⁰ is independently C₁-C₃ alkyl optionally substituted with halogen; and
(b) at least one compound selected from the group consisting of compounds (b-1) to (b-20) or agriculturally suitable salts thereof.

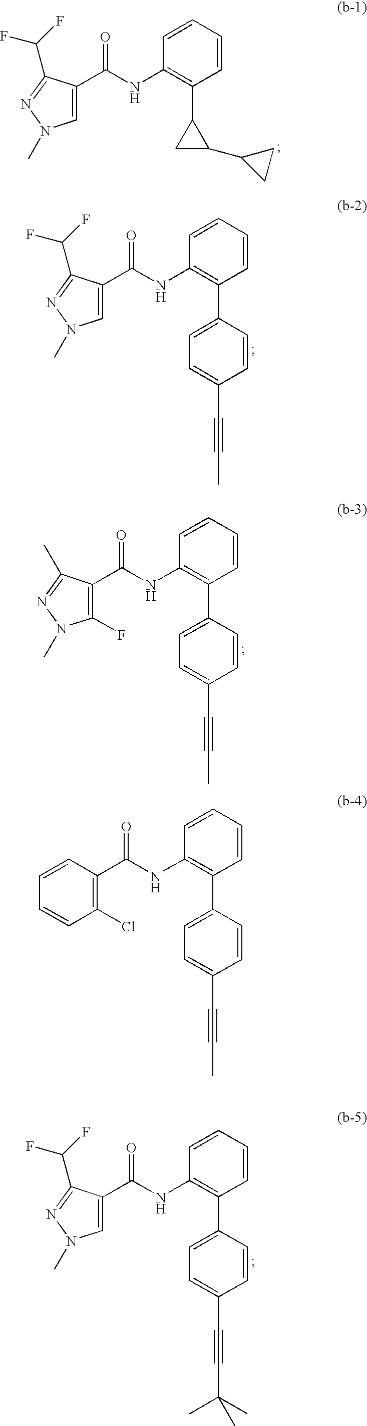

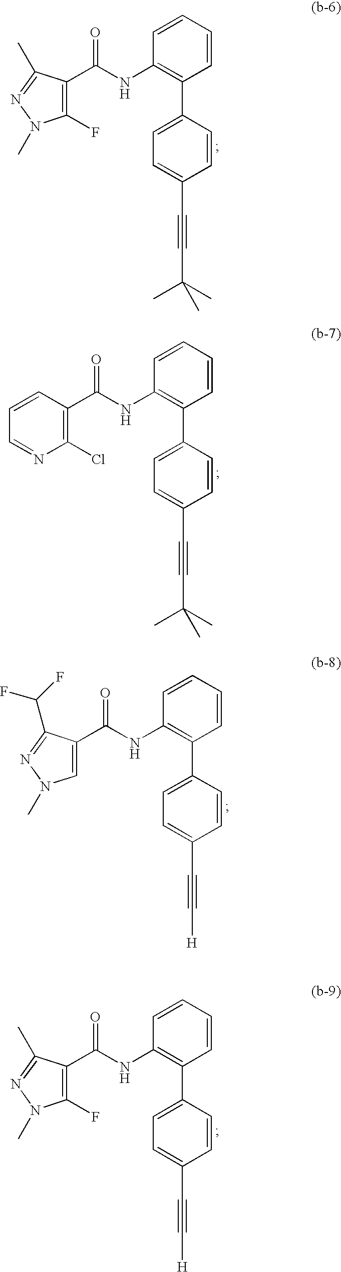

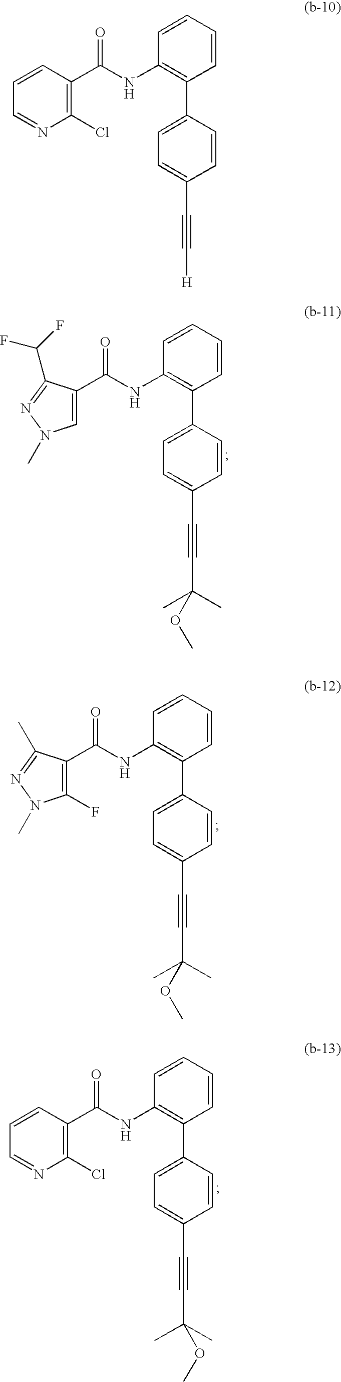

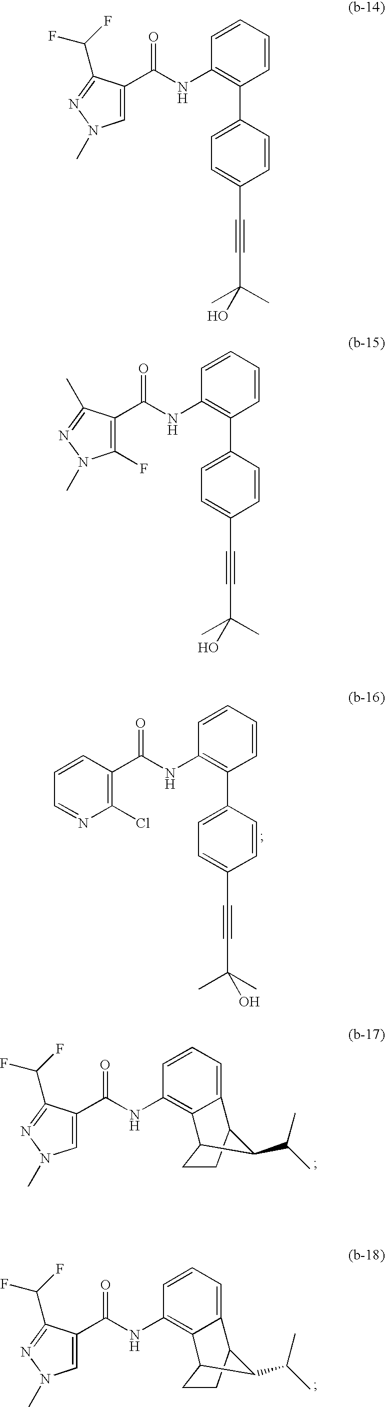

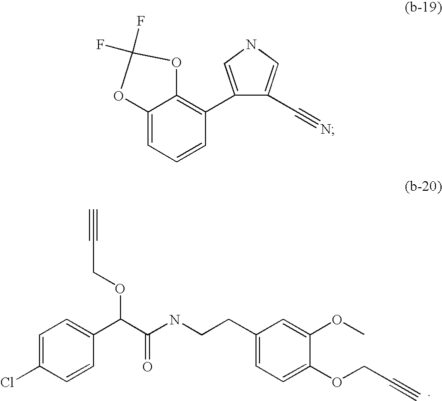

This invention also relates to a fungicidal composition comprising a fungicidally effective amount of the mixture of the invention and at least one additional component selected from the group consisting of surfactants, solid diluents and liquid diluents.

This invention also relates to a method for controlling plant diseases caused by fungal plant pathogens comprising applying to the plant or portion thereof, or to the plant seed or seedling, a fungicidally effective amount of a mixture of the invention (e.g., as a composition described herein).

In the above recitations, the term “alkyl”, used either alone or in compound words such as “alkylthio” or “haloalkyl” includes straight-chain or branched alkyl, such as, methyl, ethyl, n-propyl or i-propyl. As referred to herein “alkylene” denotes alkanediyl with a straight-chain backbone. “C₃ alkylene” in the definition of substituent A means —CH₂CH₂CH₂—, one end of which is connected to substituent W and the other end of which is connected to the remainder of Formula I through the oxygen atom as depicted.

“Alkylthio” includes methylthio and ethylthio. “Alkylsulfinyl” includes both enantiomers of an alkylsulfinyl group. Examples of “alkylsulfinyl” include CH₃S(O) and CH₃CH₂S(O).

Examples of “alkylsulfonyl” include CH₃S(O)₂ and CH₃CH₂S(O)₂. The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different.

Examples of “haloakyl” include F₃C, ClCH₂, CF₃CH₂ and CF₃CCl₂. The total number of carbon atoms in a substituent group is indicated by the “Cᵢ-Cⱼ” prefix where i and j are numbers from i to j. For example, C₁-C₃ alkyl designates methyl through propyl.

When a group contains a substituent which can be hydrogen, for example R or R5, then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer (s) when separated from the other stereoisomer (s) the skilled artisan knows how to separate, enrich, and/or to selectively prepare said stereoisomers. Accordingly, the present invention comprises compounds selected from Formula I, N-oxides and agriculturally suitable salts thereof. The compounds of the invention may be present as a mixture of stereoisomers, individual stereoisomers, or as an optically active form.

One skilled in the art will recognize that tertiary amines can form N-oxides. Synthetic methods for the preparation of N-oxides of tertiary amines are very well known by one skilled in the art including the oxidation of tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydroxirane.

These methods for the preparation of N-oxides have been extensively described and reviewed in the literature, see for example: T. L. Gilchrist in Comprehensive OrganicSynthesis, vol. 7, pp 748-750, S. V. Ley (Ed.), Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky (Ed.), Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

Agriculturally suitable salts of the compounds in the mixtures of the present invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Agriculturally suitable salts of the compounds in the mixtures of the present invention also include those formed with organic bases (e.g. pyridine, ammonia, or triethylamine) or inorganic bases (e.g. hydrides, hydroxides or carbonates of sodium, potassium, lithium, calcium, magnesium or barium) when the compound contains an acidic group such as carboxylic acid or phenol.

Embodiments of the present invention include:

### EMBODIMENT 1

A mixture comprising as component (a) a compound of Formula I, or an agriculturally suitable salt, wherein R¹ is methyl or ethyl, and R² is methyl, ethyl or cyclopropyl.

### EMBODIMENT 2

A mixture of Embodiment 1 wherein component (a) is selected from the group consisting of N-[5-trifluoromethyl-2-methyl-4-[3-(trimethylsilyl)-propoxyl]phenyl]-N-ethyl-N-methylmethanimidamide and N-[5-difluoro-methyl-2-methyl-4-[3-(trimethylsilyl)propoxyl]phenyl]-N-ethyl-N-methyl-methanimidamide.

### EMBODIMENT 3

A mixture of Embodiment 2 wherein component (a) is N-[5-trifluoro-methyl-2-methyl-4-[3-(trimethylsilyl)propoxyl]phenyl]-N-ethyl-N-methyl-methanimidamide.

### EMBODIMENT 4

A mixture of Embodiment 2 wherein component (a) is N-[5-difluoro-methyl-2-methyl-4-[3-(trimethylsilyl)propoxyl]phenyl]N-ethyl-N-methyl-methanimidamide.

Of note is a mixture comprising component (a) of any of Embodiments 1 through 4 and component (b) comprises at least one compound selected from the group consisting of (b-1), to b-14.

### EMBODIMENT 5

A mixture wherein component (b) is compound (b-1).

### EMBODIMENT 6

A mixture wherein component (b) is compound (b-2).

### EMBODIMENT 7

A mixture wherein component (b) is compound (b-3).

### EMBODIMENT 8

A mixture wherein component (b) is compound (b-4).

### EMBODIMENT 9

A mixture wherein component (b) is compound (b-5).

### EMBODIMENT 10

A mixture wherein component (b) is compound (b-6).

### EMBODIMENT 11

A mixture wherein component (b) is compound (b-7).

### EMBODIMENT 12

A mixture wherein component (b) is compound (b-8).

### EMBODIMENT 13

A mixture wherein component (b) is compound (b-9).

### EMBODIMENT 14

A mixture wherein component (b) is compound (b-10).

### EMBODIMENT 15

A mixture wherein component (b) is compound (b-1).

### EMBODIMENT 16

A mixture wherein component (b) is compound (b-12).

### EMBODIMENT 17

A mixture wherein component (b) is compound (b-13).

### EMBODIMENT 18

A mixture wherein component (b) is compound (b-14).

### EMBODIMENT 19

A mixture wherein component (b) is compound (b-15).

### EMBODIMENT 20

A mixture wherein component (b) is compound (b-16).

### EMBODIMENT 21

A mixture wherein component (b) is compound (b-17).

### EMBODIMENT 22

A mixture wherein component (b) is compound (b-18).

### EMBODIMENT 23

A mixture wherein component (b) is compound (b-19).

### EMBODIMENT 24

A mixture wherein component (b) is compound (b-20).

### EMBODIMENT 25

A mixture wherein component (b) comprises at least one compound from each of two different compounds selected from (b-1), (b-2), (b-3), (b-4), (b-5), (b-6), (b-7), (b-8), (b-9), (b-10), (b-1), (b-12), (b-13), (b-14), (b-15), (b-16), (b-17), (b-18), (b-19) and (b-20).

Preferred embodiments of the present inventions are disclosed by the following tables 1 through 7.

Also noteworthy as embodiments are fungicidal compositions of the present invention comprising a fungicidally effective amount of a mixture of Embodiments 1 to 18 and at least one additional component selected from the group consisting of surfactants, solid diluents and liquid diluents. Embodiments of the invention further include methods for controlling plant diseases caused by fungal plant pathogens comprising applying to the plant or portion thereof, or to the plant seed or seedling, a fungicidally effective amount of a mixture of Embodiments 1 to 18 (e.g., as a composition described herein).

The compounds of Formula I can be prepared by one or more of the methods and variations thereof as described in WO 2003/093224.

Tables 1 to 7 list specific compounds of Formula I useful in the fungicidal mixtures, compositions and methods of the present invention. These compounds are to be construed as illustrative and not limiting of the disclosure in any way.

The following abbreviations are used in the Tables which follow: t means tertiary, s means secondary, n means normal, i means iso, and c means cyclo.

TABLE 1

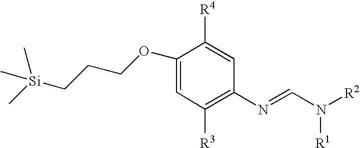

| | Component (a) | | | | |
|---|---|---|---|---|---|
| Nr. | R¹ | R² | R³ | R⁴ | Component (b) |
| 1-1 | CH₃ | CH₃ | CH₃ | CH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-2 | CH₃ | C₂H₅ | CH₃ | CH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-3 | C₂H₅ | C₂H₅ | CH₃ | CH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-4 | CH₃ | i-C₃H₇ | CH₃ | CH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-5 | CH₃ | c-C₃H₇ | CH₃ | CH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-6 | CH₃ | CH₃ | CH₃ | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-7 | CH₃ | C₂H₅ | CH₃ | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-8 | C₂H₅ | C₂H₅ | CH₃ | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-9 | CH₃ | i-C₃H₇ | CH₃ | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-10 | CH₃ | c-C₃H₇ | CH₃ | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-11 | CH₃ | CH₃ | CH₃ | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-12 | CH₃ | C₂H₅ | CH₃ | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-13 | CH₃ | C₂H₅ | CH₃ | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-14 | CH₃ | i-C₃H₇ | CH₃ | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-15 | CH₃ | c-C₃H₇ | CH₃ | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-16 | CH₃ | C₂H₅ | CH₃ | C₂H₅ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-17 | CH₃ | C₂H₅ | CH₃ | CHFCF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-18 | CH₃ | C₂H₅ | CH₃ | CF₂CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-19 | CH₃ | C₂H₅ | CH₃ | CHCl₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-20 | CH₃ | C₂H₅ | CH₃ | CCl₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-21 | CH₃ | CH₃ | H | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-22 | CH₃ | C₂H₅ | H | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-23 | C₂H₅ | C₂H₅ | H | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-24 | CH₃ | i-C₃H₇ | H | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-25 | CH₃ | c-C₃H₇ | H | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-26 | CH₃ | CH₃ | H | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-27 | CH₃ | C₂H₅ | H | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-28 | C₂H₅ | C₂H₅ | H | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-29 | CH₃ | i-C₃H₇ | H | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-30 | CH₃ | c-C₃H₇ | H | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-31 | CH₃ | C₂H₅ | I | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-32 | CH₃ | C₂H₅ | F | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-33 | CH₃ | C₂H₅ | Cl | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-34 | CH₃ | C₂H₅ | H | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-35 | CH₃ | C₂H₅ | Br | OCH₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-36 | CH₃ | CH₃ | CH₃ | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-37 | CH₃ | C₂H₅ | CH₃ | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-38 | C₂H₅ | C₂H₅ | CH₃ | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-39 | CH₃ | i-C₃H₇ | CH₃ | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-40 | CH₃ | c-C₃H₇ | CH₃ | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-41 | CH₃ | CH₃ | CH₃ | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-42 | CH₃ | C₂H₅ | CH₃ | CHF₂ | (b-1), (b-2), (b-3), (b-4), (b-5), (b-6), (b-7), |
| | | | | | (b-8), (b-9), (b-10), (b-11), (b-12), (b-13), (b |
| | | | | | 14), (b-15), (b-16), (b-17), (b-18), (b-19), |
| | | | | | (b-20); |
| 1-43 | C₂H₅ | C₂H₅ | CH₃ | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-44 | CH₃ | i-C₃H₇ | CH₃ | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-45 | CH₃ | c-C₃H₇ | CH₃ | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-46 | CH₃ | CH₃ | Cl | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-47 | CH₃ | C₂H₅ | Cl | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-48 | C₂H₅ | C₂H₅ | Cl | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-49 | CH₃ | i-C₃H₇ | Cl | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-50 | CH₃ | c-C₃H₇ | Cl | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-51 | CH₃ | CH₃ | Cl | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-52 | CH₃ | C₂H₅ | Cl | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-53 | CH₃ | C₂H₅ | Cl | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-54 | CH₃ | i-C₃H₇ | Cl | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-55 | CH₃ | c-C₃H₇ | Cl | CHF₂ | (b-1), (b-2), (b-3), (b-4), (b-5), (b-6),(b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-56 | CH₃ | CH₃ | Br | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-57 | CH₃ | C₂H₅ | Br | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-58 | C₂H₅ | C₂H₅ | Br | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-15), (b-19), |
| | | | | | (b-20); |
| 1-59 | CH₃ | i-C₃H₇ | Br | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-60 | CH₃ | c-C₃H₇ | Br | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-61 | CH₃ | CH₃ | Br | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-62 | CH₃ | C₂H₅ | Br | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-63 | C₂H₅ | C₂H₅ | Br | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-15), (b-19), |
| | | | | | (b-20); |
| 1-64 | CH₃ | i-C₃H₇ | Br | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-65 | CH₃ | c-C₃H₇ | Br | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-66 | CH₃ | C₂H₅ | I | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-67 | CH₃ | C₂H₅ | F | CF₃ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-68 | CH₃ | C₂H₅ | I | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-69 | CH₃ | C₂H₅ | F | CHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-70 | CH₃ | C₂H₅ | Cl | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |
| 1-71 | CH₃ | C₂H₅ | Br | OCHF₂ | (b-1), (b-2), (b-3), (b-4), (b-5), (b-6), (b-7), |
| | | | | | (b-8), (b-9), (b-10), (b-11), (b-12), (b-13), (b- |
| | | | | | 14), (b-15), (b-16), (b-17), (b-18), (b-19), |
| | | | | | (b-20); |

TABLE 2

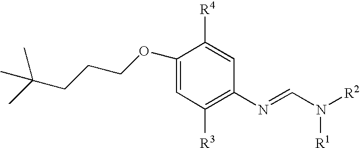

| | Component (a) | | | | |
|---|---|---|---|---|---|
| Nr. | R¹ | R² | R³ | R⁴ | |
| 2-1 | CH₃ | CH₃ | CH₃ | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-2 | CH₃ | C₂H₅ | CH₃ | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-3 | C₂H₅ | C₂H₅ | CH₃ | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-4 | CH₃ | i-C₃H₇ | CH₃ | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-5 | CH₃ | c-C₃H₇ | CH₃ | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-6 | CH₃ | CH₃ | CH₃ | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-7 | CH₃ | C₂H₅ | CH₃ | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-8 | C₂H₅ | C₂H₅ | CH₃ | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-9 | CH₃ | i-C₃H₇ | CH₃ | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-10 | CH₃ | c-C₃H₇ | CH₃ | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-11 | CH₃ | CH₃ | H | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-12 | CH₃ | C₂H₅ | H | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-13 | C₂H₅ | C₂H₅ | H | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-15), (b-19), (b-20); |
| 2-14 | CH₃ | i-C₃H₇ | H | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-15 | CH₃ | c-C₃H₇ | H | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-16 | CH₃ | CH₃ | H | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-17 | CH₃ | C₂H₅ | H | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-18 | C₂H₅ | C₂H₅ | H | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-19 | CH₃ | i-C₃H₇ | H | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-20 | CH₃ | c-C₃H₇ | H | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-21 | CH₃ | C₂H₅ | I | OCH₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-22 | CH₃ | C₂H₅ | F | OCH₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-23 | CH₃ | C₂H₅ | Cl | OCH₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-24 | CH₃ | C₂H₅ | H | OCH₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-25 | CH₃ | C₂H₅ | Br | OCH₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-26 | CH₃ | CH₃ | Cl | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-27 | CH₃ | C₂H₅ | Cl | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-28 | C₂H₅ | C₂H₅ | Cl | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-29 | CH₃ | i-C₃H₇ | Cl | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-30 | CH₃ | c-C₃H₇ | Cl | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-31 | CH₃ | CH₃ | Cl | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-32 | CH₃ | C₂H₅ | Cl | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-33 | C₂H₅ | C₂H₅ | Cl | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-34 | CH₃ | i-C₃H₇ | Cl | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-35 | CH₃ | c-C₃H₇ | Cl | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-36 | CH₃ | CH₃ | Br | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); 22 |
| 2-37 | CH₃ | C₂H₅ | Br | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-38 | C₂H₅ | C₂H₅ | Br | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-39 | CH₃ | i-C₃H₇ | Br | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-40 | CH₃ | c-C₃H₇ | Br | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-41 | CH₃ | CH₃ | Br | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-42 | CH₃ | C₂H₅ | Br | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-43 | C₂H₅ | C₂H₅ | Br | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-44 | CH₃ | i-C₃H₇ | Br | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-45 | CH₃ | c-C₃H₇ | Br | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-46 | CH₃ | ′C₂H₅ | I | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-47 | CH₃ | C₂H₅ | F | CF₃ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-48 | CH₃ | C₂H₅ | I | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-49 | CH₃ | C₂H₅ | F | CHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-50 | CH₃ | C₂H₅ | Cl | OCHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |
| 2-51 | CH₃ | C₂H₅ | Br | OCHF₂ | (b-1), (b-2), (b-3), (b-4), (b-5), (b-6), (b-7), (b- |
| | | | | | 8), (b-9), (b-10), (b-11), (b-12), (b-13), (b-14), |
| | | | | | (b-15), (b-16), (b-17), (b-18), (b-19), (b-20); |

TABLE 3

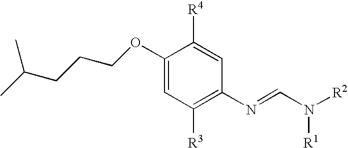

| Component (a) | | | | | |
|---|---|---|---|---|---|
| Nr. | R¹ | R² | R³ | R⁴ | Component (b) |
| 3-1 | CH₃ | CH₃ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-2 | CH₃ | C₂H₅ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-3 | C₂H₅ | C₂H₅ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-4 | CH₃ | i-C₃H₇ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-5 | CH₃ | c-C₃H₇ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-6 | CH₃ | CH₃ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-7 | CH₃ | C₂H₅ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-8 | C₂H₅ | C₂H₃ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-9 | CH₃ | i-C₃H₇ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-10 | CH₃ | c-C₃H₇ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-11 | CH₃ | CH₃ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-12 | CH₃ | C₂H₅ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-13 | C₂H₅ | C₂H₅ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-14 | CH₃ | i-C₃H₇ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-15 | CH₃ | c-C₃H₇ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-16 | CH₃ | CH₃ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-17 | CH₃ | C₂H₅ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-18 | C₂H₅ | C₂H₅ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-19 | CH₃ | i-C₃H₇ | H | CHF₂ | (b-1), (b-2), (b-3), (b-4), (b-5), (b-6), (b-7), (b-8), (b-9), |
| | | | | | (b-10), (b11), (b-12), (b-13), (b-14), (b-15), (b-16), (b-17), |
| | | | | | (b-18), (b-19), (b-20); |
| 3-20 | CH₃ | c-C₃H₇ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-21 | CH₃ | C₂H₅ | I | OCH₃ | (b-1), (b-2), (b-3), (b-4), (b-5), (b-6), (b-7), (b-8), (b-9), |
| | | | | | (b-10), (b11), (b-12), (b-13), (b-14), (b-15), (b-16), (b-17), |
| | | | | | (b-18), (b-19), (b-20); |
| 3-22 | CH₃ | C₂H₅ | F | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-23 | CH₃ | C₂H₅ | Cl | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-24 | CH₃ | C₂H₅ | H | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-25 | CH₃ | C₂H₅ | Br | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-26 | CH₃ | CH₃ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-27 | CH₃ | C₂H₅ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-28 | C₂H₅ | C₂H₅ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-29 | CH₃ | i-C₃H₇ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-30 | CH₃ | c-C₃H₇ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-31 | CH₃ | CH₃ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-32 | CH₃ | C₂H₅ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-33 | C₂H₅ | C₂H₅ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-34 | CH₃ | i-C₃H₇ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-35 | CH₃ | c-C₃H₇ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-36 | CH₃ | CH₃ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-37 | CH₃ | C₂H₅ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-38 | C₂H₅ | C₂H₅ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-39 | CH₃ | i-C₃H₇ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-40 | CH₃ | c-C₃H₇ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-41 | CH₃ | CH₃ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-42 | CH₃ | C₂H₅ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-43 | C₂H₅ | C₂H₅ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-44 | CH₃ | i-C₃H₇ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-45 | CH₃ | c-C₃H₇ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-46 | CH₃ | C₂H₅ | I | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-47 | CH₃ | C₂H₅ | F | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-48 | CH₃ | C₂H₅ | I | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-49 | CH₃ | C₂H₅ | F | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-50 | CH₃ | C₂H₅ | Cl | OCHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 3-51 | CH₃ | C₂H₅ | Br | OCHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |

TABLE 4

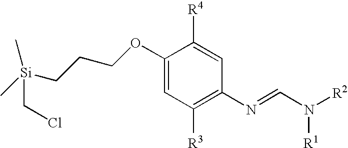

| Component (a) | | | | | |
|---|---|---|---|---|---|
| Nr. | R¹ | R² | R³ | R⁴ | Component (b) |
| 4-1 | CH₃ | CH₃ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-2 | CH₃ | C₂H₅ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-3 | C₂H₅ | C₂H₅ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-4 | CH₃ | i-C₃H₇ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-5 | CH₃ | c-C₃H₇ | CH₃ | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-6 | CH₃ | CH₃ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-7 | CH₃ | C₂H₅ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-8 | C₂H₅ | C₂H₅ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-9 | CH₃ | i-C₃H₇ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-10 | CH₃ | c-C₃H₇ | CH₃ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-11 | CH₃ | CH₃ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-12 | CH₃ | C₂H₅ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-13 | C₂H₅ | C₂H₅ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-14 | CH₃ | i-C₃H₇ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-15 | CH₃ | c-C₃H₇ | H | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-16 | CH₃ | CH₃ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-17 | CH₃ | C₂H₅ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-18 | C₂H₅ | C₂H₅ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-19 | CH₃ | i-C₃H₇ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-20 | CH₃ | c-C₃H₇ | H | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-21 | CH₃ | C₂H₅ | I | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-22 | CH₃ | C₂H₅ | F | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-23 | CH₃ | C₂H₅ | Cl | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-24 | CH₃ | C₂H₅ | H | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-25 | CH₃ | C₂H₅ | Br | OCH₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-26 | CH₃ | CH₃ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-27 | CH₃ | C₂H₅ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-28 | C₂H₅ | C₂H₅ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-29 | CH₃ | i-C₃H₇ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-30 | CH₃ | c-C₃H₇ | Cl | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-31 | CH₃ | CH₃ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-32 | CH₃ | C₂H₅ | Cl′ | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-33 | C₂H₅ | C₂H₅ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-34 | CH₃ | i-C₃H₇ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-35 | CH₃ | c-C₃H₇ | Cl | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-36 | CH₃ | CH₃ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-37 | CH₃ | C₂H₅ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-38 | C₂H₅ | C₂H₅ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-39 | CH₃ | i-C₃H₇ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-40 | CH₃ | c-C₃H₇ | Br | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-41 | CH₃ | CH₃ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-42 | CH₃ | C₂H₅ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-43 | C₂H₅ | C₂H₅ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-44 | CH₃ | i-C₃H₇ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-45 | CH₃ | c-C₃H₇ | Br | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-46 | CH₃ | C₂H₅ | I | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-47 | CH₃ | C₂H₅ | F | CF₃ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-48 | CH₃ | C₂H₅ | I | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-49 | CH₃ | C₂H₅ | F | CHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-50 | CH₃ | C₂H₅ | Cl | OCHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |
| 4-51 | CH₃ | C₂H₅ | Br | OCHF₂ | (b-1), (b-2), (b-3), (b-4), (b-5), (b-6), (b-7), (b-8), (b-9), |
| | | | | | (b-10), (b-11), (b-12), (b-13), (b-14), (b-15), (b-16), (b-17), |
| | | | | | (b-18), (b-19), (b-20); |

TABLE 5

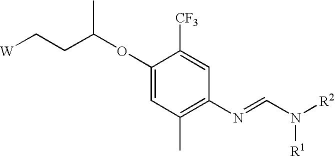

| Component (a) | | | | |
|---|---|---|---|---|
| Nr. | W | R¹ | R² | Component (b) |
| 5-1 | (CH₃)₃Si | CH₃ | CH₃ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-2 | (CH₃)₃Si | CH₃ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-3 | (CH₃)₃Si | C₂H₅ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-4 | (CH₃)₃Si | CH₃ | i-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-5 | (CH₃)₃Si | CH₃ | c-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-6 | ClCH₂(CH₃)₂Si | CH₃ | CH₃ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-7 | ClCH₂(CH₃)₂Si | CH₃ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-8 | ClCH₂(CH₃)₂Si | C₂H₅ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-9 | ClCH₂(CH₃)₂Si | CH₃ | c-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-10 | (CH₃)₃C | CH₃ | CH₃ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-11 | (CH₃)₃C | CH₃ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-12 | (CH₃)₃C | C₂H₅ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-13 | (CH₃)₃C | CH₃ | i-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-14 | (CH₃)₃C | CH₃ | c-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-15 | (CH₃)₂CH | CH₃ | CH₃ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-16 | (CH₃)₂CH | CH₃ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-17 | (CH₃)₂CH | C₂H₅ | C₂H₅ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |
| 5-18 | (CH₃)₂CH | CH₃ | c-C₃H₇ | (b-1), (b-2), (b-3), (b-4), (b-5), (b-6), (b-7), (b-8), (b-9), |
| | | | | (b-10), (b-11), (b-12), (b-13), (b-14), (b-15), (b-16), (b-17), |
| | | | | (b-18), (b-19), (b-20); |

TABLE 6

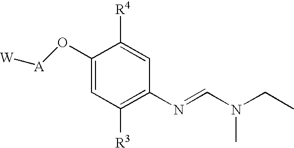

| Component (a) | | | | | |
|---|---|---|---|---|---|
| Nr. | W | A | R³ | R⁴ | Component (b) |
| 6-1 | BrCH₂(CH₃)₂Si | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-2 | FCH₂(CH₃)₂Si | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-3 | ICH₂(CH₃)₂Si | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-4 | BrCH₂(CH₃)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-5 | FCH₂(CH₃)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-6 | ICH₂(CH₃)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-7 | (CH₃)₂CH | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-8 | (CH₃)₃C | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-9 | (CH₃)₃Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-10 | ClCH₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-11 | ICH₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-12 | BrCH₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-13 | FCH₂(CH₃)₂Si | CH₂CH₂CH₂ | CH₃ | C1 | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-14 | ClCH₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-15 | (CH₃)₂CH | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-16 | (CH₃)₃C | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-17 | (CH₃)₃Si | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-18 | ClCH₂(CH₃)₂Si | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-19 | ICH₂(CH₃)₂Si | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-20 | BrCH₂(CH₃)₂Si | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-21 | FCH₂(CH₃)₂Si | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-22 | (CH₃)₂CH | CH₂CH₂CH₂ | CH₃ | F | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-23 | (CH₃)₃C | CH₂CH₂CH₂ | CH₃ | F | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-24 | (CH₃)₃Si | CH₂CH₂CH₂ | CH₃ | F | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-25 | ClCH₂(CH₃)₂Si | CH₂CH₂CH₂ | CH₃ | F | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-26 | (CH₃)₂CH | CH₂CH₂CH₂ | CH₃ | I | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-27 | (CH₃)₃C | CH₂CH₂CH₂ | CH₃ | I | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-28 | (CH₃)₃Si | CH₂CH₂CH₂ | CH₃ | I | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-29 | ClCH₂(CH₃)₂Si | CH₂CH₂CH₂ | CH₃ | I | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-30 | CH₃CH₂CH₂(CH₃)₂Si | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-31 | C₂H₅(CH₃)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-32 | CH₃(C₂H₅)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-33 | CH₃CH₂CH₂(CH₃)₂Si | CH₂CH₂CH₂ | CH₃ | CBF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-34 | C₂H₅(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-35 | CH₃(C₂H₅)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-36 | CH₃CH₂CH₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-37 | ClCF₂(CH₃)₂Si | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-38 | CHF₂(CH₃)₂C | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-39 | ClCF₂(CH₃)₂Si | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-40 | CHF₂(CH₃)₂C | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-41 | ClCF₂(CH₃)₂Si | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-42 | CHF₂(CH₃)₂C | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-43 | (CH₃)₃Si | CH₂CH(CH₃)CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-44 | (CH₃)₃Si | CH₂CH(CH₃)CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-45 | (CH₃)₃Si | CH(CH₃)CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-46 | (CH₃)₃Si | CH(CH₃)CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-47 | C₂H₅(CH₃)₂C | CH₂CH₂CH₂ | CH₃ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-48 | C₂H₅(CH₃)₂C | CH₂CH₂CH₂ | CH₃ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-49 | C₂H₅(CH₃)₂C | CH₂CH₂CH₂ | CH₃ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-50 | C₂H₅(CH₃)₂C | CH₂CH₂CH₂ | CH₃ | Br | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-51 | (CH₃)₂CH | CH₂CH₂CH₂ | C₂H₅ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-52 | (CH₃)₃C | CH₂CH₂CH₂ | C₂H₅ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-53 | (CH₃)₃Si | CH₂CH₂CH₂ | C₂H₅ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-54 | ClCH₂(CH₃)₂Si | CH₂CH₂CH₂ | C₂H₅ | CF₃ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-55 | (CH₃)₃Si | CH₂CH₂CH₂ | C₂H₅ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-56 | ClCH₂(CH₃)₂Si | CH₂CH₂CH₂ | C₂H₅ | CHF₂ | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |
| 6-57 | (CH₃)₃Si | CH₂CH₂CH₂ | C₂H₅ | Cl | (b-1), (b-2), (b-3), (b-4), (b-5), (b-6), (b-7), |
| | | | | | (b-8), (b-9), (b-10), (b-11), (b-12), (b-13), |
| | | | | | (b-14), (b-15), (b-16), (b-17), (b-18), (b-19), (b-20); |

In Table 6 the left end of the radical shown for A connects to W and the right end of the radical shown for W connects to the oxygen atom of the remaining part of the molecular structure.

TABLE 7

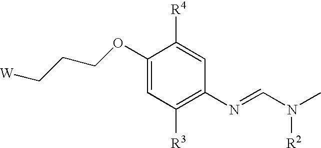

| Component (a) | | | | | |
|---|---|---|---|---|---|
| Nr. | W | R² | R³ | R⁴ | Component (b) |
| 7-1 | (CH₃)₃Si | C₂H₅ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-2 | (CH₃)₃C | C₂H₅ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-3 | (CH₃)₂CH | C₂H₅ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-4 | (CH₃)₃Si | C₂H₅ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-5 | (CH₃)₃C | C₂H₅ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-6 | (CH₃)₂CH | C₂H₅ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-7 | (CH₃)₃Si | C₂H₅ | CH₃ | S(O)₂CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-8 | (CH₃)₃C | C₂H₅ | CH₃ | S(0)₂CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-9 | (CH₃)₂CH | C₂H₃ | CH₃ | S(O)2CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-10 | (CH₃)₃Si | i-C₃H₇ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-11 | (CH₃)₃C | i-C₃H₇ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-12 | (CH₃)₂CH | i-C₃H₇ | CH₃ | SCH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b20); |
| 7-13 | (CH₃)₃Si | i-C₃H₇ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-14 | (CH₃)₃C | i-C₃H₇ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-15 | (CH₃)₂CH | i-C₃H₇ | CH₃ | S(O)CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-16 | (CH₃)₃Si | i-C₃H₇ | CH₃ | S(O)₂CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-17 | (CH₃)₃C | i-C₃H₇ | CH₃ | S(0)₂CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |
| 7-18 | (CH₃)₂CH | i-C₃H₇ | CH₃ | S(0)₂CH₃ | (b-1), (b-2), (b-3), (b-4), (b-5), (b-6), (b-7), (b-8), |
| | | | | | (b-9), (b-10), (b-11), (b-12), (b-13), (b-14), (b-15), |
| | | | | | (b-16), (b-17), (b-18), (b-19), (b-20); |

The fungicidal compound according to formula (b-1) can be prepared as described in WO 2006/015866.

The fungicidal compound according to formulas (b-2), (b-3), (b-4), (b-5), (b-6), (b-7), (b-8), (b-9), (b-10), (b-11), (b-12), (b-13), (b-14), (b-15), and (b-16) can be prepared as described in WO 2004/058723.

The fungicidal compound according to formulas (b-17) and (b-18) can be prepared as described in WO 2004/035589.

The fungicidal compound according to formula (b-19) can be prepared as described in EP-A-00206999.

The fungicidal compound according to formula (b-20); can be prepared as described in WO 2001/087822.

Moreover, they have been described in published patents and scientific journal papers. Most of these compounds are commercially available as active ingredients in fungicidal products.

### Formulation/Utility

Mixtures of this invention will generally be used as a formulation or composition comprising at least one carrier selected from agriculturally suitable liquid diluents, solid diluents and surfactants. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. The active ingredients can be (micro) encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation. The formulations will typically contain effective amounts (e.g., from 0.01-99.99 weight percent) of active ingredients together with diluent and/or surfactant within the following approximate ranges which add up to 100 percent by weight.

The compositions according to the present invention comprise component (a) and component (b) in a weight ratio of component (a) to component (b) from 1:100 to 100:1, preferably from 1:50 to 50:1, most preferably from 1:10 to 10:1.

| | Weight Percent | | |
|---|---|---|---|
| | Active Ingredients | Diluent | Surfactant |
| Water-Dispersible | 5-90 | 0-94 | 1-15 |
| and Water-soluble | | | |
| Granules, Tablets and | | | |
| Powders | | | |
| Suspensions, | 5-50 | 40-95 | 0-25 |
| Emulsions, Solutions | | | |
| (including Emulsi- | | | |
| fiable Concentrates) | | | |
| Dusts | 1-25 | 70-99 | 0-5 |
| Granules and Pellets | 0.01-99 | 5-99.99 | 0-15 |
| High Strength | 90-99 | 0-10 | 0-2 |
| Compositions | | | |

Typical solid diluents are described in Watkins et al., Handbook of Insecticide Dust Diluents and Carriers, 2nd edition, Dorland Books, Caldwell, N.J., Typical liquid diluents are described in Marsden, Solvents Guide, 2nd edition., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethylsulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Preferred suspension concentrates include those containing, in addition to the active ingredient, from 5 to 20% nonionic surfactant (for example, polyethoxylated fatty alcohols) optionally combined with 50-65% liquid diluents and up to 5% anionic surfactants. Granules and pellets can be prepared by spraying the active material upon preformed granular carriers or by agglomeration techniques. See Browning, “Agglomeration”, Chemical Engineering, Dec. 4, 1967, pp 147-48, Perry's ChemicalEngineer's Handbook, 4th edition, McGraw-Hill, New York, 1963, pages 8-57 and following, and World Patent Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE U.S. Pat. No. 3,246,493. Tablets can be prepared as taught in U.S. Pat. No. 5,180,587, U.S. Pat. No. 5,232,701 and U.S. Pat. No. 5,208,030. Films can be prepared as taught in GB Patent 2,095,558 and U.S. Pat. No. 3,299,566.

For further information regarding the art of formulation, see U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th edition., Blackwell Scientific Publications, Oxford, 1989.

The active compound combinations according to the invention have very good fungicidal properties and are suitable for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combinations according to the invention are particularly suitable for controlling Blumeria graminis, Septoria Tritici, Puccinaria teres, Pyrenophora teres, Tilletia caries and Ustillago nuda.

Some pathogens causing fungal diseases which come under the generic names listed above may be mentioned by way of example, but not by way of limitation:

Powdery Mildew Diseases Such as

Blumeria diseases caused for example by Blumeria graminis

Podosphaera diseases caused for example by Podosphaera leucotricha

Sphaerotheca diseases caused for example by Sphaerotheca fuliginea

Uncinula diseases caused for example by Uncinula necator

Rust Diseases Such as

Gymnosporangium diseases caused for example by Gymnosporangium sabinae

Hemileia diseases caused for example by Hemileia vastatrix

Phakopsora diseases caused for example by Phakopsora pachyrhizi and Phakopsora meibomiae

Puccinia diseases caused for example by Puccinia recondita;

Uromyces diseases caused for example by Uromyces appendiculatus

Oomycete Diseases Such as

Bremia diseases caused for example by Bremia lactucae

Peronospora diseases caused for example by Peronospora pisi and Peronospora brassicae

Phytophthora diseases caused for example by Phytophthora infestans

Plasmopara diseases caused for example by Plasmopara viticola

Pseudoperonospora diseases caused for example by Pseudoperonospora humuli and Pseudoperonospora cubensis

Pythium diseases caused for example by Pythium ultimum

Leafspot, Leaf Blotch and Leaf Blight Diseases Such as

Alternaria diseases caused for example by Alternaria solani

Cercospora diseases caused for example by Cercospora beticola

Cladiosporium diseases caused for example by Cladiosporium cucumerinum

Cochliobolus diseases caused for example by Cochliobolus sativus

(Conidiaform: Drechslera, Syn: Helminthosporium);

Colletotrichum diseases caused for example by Colletotrichum lindemuthianum

Cycloconium diseases caused for example by Cycloconium oleaginum

Diaporthe diseases caused for example by Diaporthe citri

Elsinoe diseases caused for example by Elsinoe fawcettii

Gloeosporium diseases caused for example by Gloeosporium laeticolor

Glomerella diseases caused for example by Glomerella cingulata

Guignardia diseases caused for example by Guignardia bidwellii
Leptosphaeria diseases caused for example by Leptosphaeria maculans

Magnaporthe diseases caused for example by Magnaporthe grisea

Mycosphaerella diseases caused for example by Mycosphaerella graminicola and Mycosphaerella fijiensis

Phaeosphaeria diseases caused for example by Phaeosphaeria nodorum

Pyrenophora diseases caused for example by Pyrenophora teres

Ramularia-diseases caused for example by Ramularia collo-cygni

Rhynchosporium diseases caused for example by Rhynchosporium secalis

Septoria diseases caused for example by Septoria apii;

Typhula diseases caused for example by Thyphula incarnata

Venturia diseases caused for example by Venturia inaequalis

Root- and Stem Diseases Such as

Corticium diseases caused for example by Corticium graminearum

Fusarium diseases caused for example by Fusarium oxysporum

Gaeumannomyces diseases caused for example by Gaeumannomyces graminis

Rhizoctonia diseases caused for example by Rhizoctonia solani

Tapesia diseases caused for example by Tapesia acuformis

Thielaviopsis diseases caused for example by Thielaviopsis basicola

Ear and Panicle Diseases Including Maize Cob Such as

Alternaria diseases caused for example by Alternaria spp.

Aspergillus diseases caused for example by Aspergillus flavus

Cladosporium diseases caused for example by Cladiosporium cladosporioides

Claviceps diseases caused for example by Claviceps purpurea

Fusarium diseases caused for example by Fusarium culmorum

Gibberella diseases caused for example by Gibberella zeae

Monographella diseases caused for example by Monographella nivalis

Smut- and Bunt Diseases Such as

Sphacelotheca diseases caused for example by Sphacelotheca reiliana

Tilletia diseases caused for example by Tilletia caries

Urocystis diseases Urocystis occulta

Ustilago diseases caused for example by Ustilago nuda;

Fruit Rot and Mould Diseases Such as

Aspergillus diseases caused for example by Aspergillus flavus

Botrytis diseases caused for example by Botrytis cinerea

Penicillium diseases caused for example by Penicillium expansum and Penicillium purpurogenum

Sclerotinia diseases caused for example by Sclerotinia sclerotiorum;

Verticillium diseases caused for example by Verticillium alboatrum

Seed- and Soilborne Decay, Mould, Wilt, Rot and Damping-Off Diseases

Seed- and Soilbome Decay, Mould, Wilt, Rot and Damping-Off Diseases

Alternaria diseases caused for example by Alternaria brassicicola

Aphanomyces diseases caused for example by Aphanomyces euteiches

Ascochyta diseases caused for example by Ascochyta lentis

Aspergillus diseases caused for example by Aspergillus flavus

Cladosporium diseases caused for example by Cladosporium herbarum

Cochliobolus diseases caused for example by Cochliobolus sativus

(Conidiaform: Drechslera, Bipolaris Syn: Helminthosporium);

Colletotrichum diseases caused for example by Colletotrichum coccodes;

Fusarium diseases caused for example by Fusarium culmorum;

Gibberella diseases caused for example by Gibberella zeae;

Macrophomina diseases caused for example by Macrophomina phaseolina

Monographella diseases caused for example by Monographella nivalis;

Penicillium diseases caused for example by Penicillium expansum

Phoma diseases caused for example by Phoma lingam

Phomopsis diseases caused for example by Phomopsis sojae;

Phytophthora diseases caused for example by Phytophthora cactorum;

Pyrenophora diseases caused for example by Pyrenophora graminea

Pyricularia diseases caused for example by Pyricularia oryzae;

Pythium diseases caused for example by Pythium ultimum;

Rhizoctonia diseases caused for example by Rhizoctonia solani;

Rhizopus diseases caused for example by Rhizopus oryzae

Sclerotium diseases caused for example by Sclerotium rolfsii;

Septoria diseases caused for example by Septoria nodorum;

Typhula diseases caused for example by Typhula incarnata;

Verticillium diseases caused for example by Verticillium dahliae

Fusarium diseases caused for example by Fusarium culmorum

Phytophthora diseases caused for example by Phytophthora cactorum

Pythium diseases caused for example by Pythium ultimum

Rhizoctonia diseases caused for example by Rhizoctonia solani

Sclerotium diseases caused for example by Sclerotium rolfsii

Canker, Broom and Dieback Diseases Such as

Nectria diseases caused for example by Nectria galligena

Blight Diseases Such as

Monilinia diseases caused for example by Monilinia laxa

Leaf Blister or Leaf Curl Diseases Including Deformation of Blooms and Fruits Such as

Taphrina diseases caused for example by Taphrina deformans

Decline Diseases of Wooden Plants Such as

Esca disease caused for example by Phaeomoniella clamydospora and Phaeoacremonium aleophilum and Fomitiporia mediterranea

Diseases of Flowers and Seeds such as

Botrytis diseases caused for example by Botrytis cinerea

Diseases of Tubers Such as

Rhizoctonia diseases caused for example by Rhizoctonia solani

Helminthosporium diseases caused for example by Helminthosporium solani

Diseases caused by Bacterial Organisms Such as

Xanthomanas species for example Xanthomonas campestris pv. Oryzae

Pseudomonas species for example Pseudomonas syringae pv. Lachrymans

Erwinia species for example Erwinia amylovora

The compounds related to this invention are preferably used to control the following soybean diseases:

Fungal Diseases of the Foliage, Upper Stems, Pods and Seeds for example

Alternaria leaf spot (Alternaria spec. atrans tenuissima), Anthracnose (Colletotrichum gloeosporoides dematium var. truncatum), Brown spot (Septoria glycines), Cercospora leaf spot and blight (Cercospora kikuchii), Choanephora leaf blight (Choanephora infundibulifera trispora (Syn.)), Dactuliophora leaf spot (Dactuliophora glycines), Downy Mildew (Peronospora manshurica), Drechslera blight (Drechslera glycini), Frogeye Leaf spot (Cercospora sojina), Leptosphaerulina Leaf Spot (Leptosphaerulina trifolii), Phyllostica Leaf Spot (Phyllosticta sojaecola), Pod and Stem Blight (Phomopsis sojae), Powdery Mildew (Microsphaera diffusa), Pyrenochaeta Leaf Spot (Pyrenochaeta glycines), Rhizoctonia Aerial, Foliage, and Web Blight (Rhizoctonia solani), Rust (Phakopsora pachyrhizi, Phakopsora meibomiae), Scab (Sphaceloma glycines), Stemphylium Leaf Blight (Stemphylium botryosum), Target Spot (Corynespora cassiicola)

Fungal Disease of the Roots and Lower Stems for Example

Black Root Rot (Calonectria crotalariae), Charcoal Rot (Macrophomina phaseolina), Fusarium Blight or Wilt, Root Rot, and Pod and Collar Rot (Fusarium oxysporum, Fusarium orthoceras, Fusarium semitectum, Fusarium equiseti), Mycoleptodiscus Root Rot (Mycoleptodiscus terresiris), Neocosmospora (Neocosmopspora vasinfecta), Pod and Stem Blight (Diaporthe phaseolorum), Stem Canker (Diaporthe phaseolorum var. caulivora), Phytophthora Rot (Phytophthora megasperna), Brown Stem Rot (Phialophora gregata), Pythium Rot (Pythium aphanidermatum, Pythium irregulare, Pythium debaryanum, Pythium myriotylum, Pythium ultimum), Rhizoctonia Root Rot, Stem Decay, and Damping-Off (Rhizoctonia solani), Sclerotinia Stem Decay (Sclerotinia sclerotiorum), Sclerotinia Southern Blight (Sclerotinia rolfsii), Thielaviopsis Root Rot (Thielaviopsis basicola).

The fact that the active compound combinations are well tolerated by plants at the concentrations required for controlling plant diseases permits a treatment of entire plants (above-ground parts of plants and roots), of propagation stock and seed, and of the soil. The active compound combinations according to the invention can be used for foliar application or else as seed dressings.

The fact that the active compounds which can be used are well tolerated by plants at the concentrations required for controlling plant diseases permits a treatment of the seed. Accordingly, the active compounds according to the invention can be used as seed dressings.

A large part of the damage to crop plants which is caused by phytopathogenic fungi occurs as early as when the seed is attacked during storage and after the seed is introduced into the soil, during and immediately after germination of the plants. This phase is particularly critical since the roots and shoots of the growing plant are particularly sensitive and even minor damage can lead to the death of the whole plant. Protecting the seed and the germinating plant by the use of suitable compositions is therefore of particularly great interest.

The control of phytopathogenic fungi which damage plants post-emergence is carried out primarily by treating the soil and the above-ground parts of plants with crop protection agents. Owing to the concerns regarding a possible impact of crop protection agents on the environment and the health of man and animals, there are efforts to reduce the amount of active compounds applied.

The control of phytopathogenic fungi by treating the seeds of plants has been known for a long time and is subject-matter of continuous improvements. However, the treatment of seed frequently entails a series of problems which cannot always be solved in a satisfactory manner. Thus, it is desirable to develop methods for protecting the seed and the germinating plant which dispense with the additional application of crop protection agents after sowing or after the emergence of the plants or where additional applications are at least reduced. It is furthermore desirable to optimize the amount of active compound employed in such a way as to provide maximum protection for the seed and the germinating plant from attack by phytopathogenic fungi, but without damaging the plant itself by the active compound employed. In particular, methods for the treatment of seed should also take into consideration the intrinsic fungicidal properties of transgenic plants in order to achieve optimum protection of the seed and the germinating plant with a minimum of crop protection agents being employed.

The present invention therefore in particular also relates to a method for the protection of seed and germinating plants from attack by phytopathogenic fungi, by treating the seed with a composition according to the invention.

The invention likewise relates to the use of the compositions according to the invention for the treatment of seed for protecting the seed and the germinating plant from phytopathogenic fungi.

Furthermore, the invention relates to seed which has been treated with a composition according to the invention so as to afford protection from phytopathogenic fungi.

One of the advantages of the present invention is that the particular systemic properties of the compositions according to the invention mean that treatment of the seed with these compositions not only protects the seed itself, but also the resulting plants after emergence, from phytopathogenic fungi. In this manner, the immediate treatment of the crop at the time of sowing or shortly thereafter can be dispensed with.

Furthermore, it must be considered as advantageous that the mixtures according to the invention can also be employed in particular in transgenic seed.

The compositions according to the invention are suitable for protecting seed of any plant variety which is employed in agriculture, in the greenhouse, in forests or in horticulture. In particular, this takes the form of seed of cereals (such as wheat, barley, rye, millet and oats), maize, cotton, soya beans, rice, potatoes, sunflowers, beans, coffee, beet (for example sugar beet and fodder beet), peanuts, vegetables (such as tomatoes, cucumbers, onions and lettuce), lawn and ornamental plants. The treatment of seed of cereals (such as wheat, barley, rye and oats), maize and rice is of particular importance.

In the context of the present invention, the composition according to the invention is applied to the seed either alone or in a suitable formulation. Preferably, the seed is treated in a state which is stable enough to avoid damage during treatment. In general, the seed may be treated at any point in time between harvest and sowing. The seed usually used has been separated from the plant and freed from cobs, shells, stalks, coats, hairs or the flesh of the fruits. Thus, for example, it is possible to use seed which has been harvested, cleaned and dried to a moisture content of below 15% by weight. Alternatively, it is also possible to use seed which, after drying, has, for example, been treated with water and then dried again.

When treating the seed, care must generally be taken that the amount of the composition according to the invention applied to the seed and/or the amount of further additives is chosen in such a way that the germination of the seed is not adversely affected, or that the resulting plant is not damaged. This must be borne in mind in particular in the case of active compounds which may have phytotoxic effects at certain application rates.

The compositions according to the invention can be applied directly, that is to say without comprising further components and without having been diluted. In general, it is preferable to apply the composition to the seed in the form of a suitable formulation. Suitable formulations and methods for the treatment of seed are known to the skilled worker and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active compound combinations according to the invention are also suitable for increasing the yield of crops. In addition, they show reduced toxicity and are well tolerated by plants.

According to the invention, it is possible to treat all plants and parts of plants. Plants are to be understood here as meaning all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multilayer coating.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof, are treated. The term “parts” or “parts of plants” or “plant parts” has been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are emphasized are in particular increased defense of the plants against insects, by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucoton® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned also include the varieties sold under the name Clearfield® (for example maize). Of course, these statements also apply to plant cultivars which have these genetic traits or genetic traits still to be developed, and which will be developed and/or marketed in the future.

Depending on their particular physical and/or chemical properties, the active compound combinations according to the invention can be converted into the customary formulations, such as solutions, emulsions, suspensions, powders, dusts, foams, pastes, soluble powders, granules, aerosols, suspoemulsion concentrates, natural and synthetic materials impregnated with active compound and microencapsulations in polymeric substances and in coating compositions for seeds, and ULV cool and warm fogging formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water.

Liquefied gaseous extenders or carriers are to be understood as meaning liquids which are gaseous at standard temperature and under atmospheric pressure, for example aerosol propellants such as butane, propane, nitrogen and carbon dioxide.

Suitable solid carriers are: for example ammonium salts and ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, pumice, marble, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methylcellulose.

Tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The active compound content of the use forms prepared from the commercial formulations may be varied within wide ranges. The concentration of active compound of the use forms for controlling animal pests, such as insects and acarids, may be from 0.0000001 to 95% by weight of active compound and is preferably from 0.0001 to 1% by weight. Application is in a manner adapted to the use forms.

The formulations for controlling unwanted phytopathogenic fungi generally comprise between 0.1 and 95 percent by weight of active compound, preferably between 0.5 and 90%.

The active compound combinations according to the invention can be used as such, in the form of their formulations or as the use forms prepared therefrom, such as ready-to-use solutions, emulsifiable concentrates, emulsions, suspensions, wettable powders, soluble powders, dusts and granules. They are used in a customary manner, for example by watering (drenching), drip irrigation, spraying, atomizing, broadcasting, dusting, foaming, spreading-on, and as a powder for dry seed treatment, a solution for seed treatment, a water-soluble powder for seed treatment, a water-soluble powder for slurry treatment, or by encrusting.

The active compound combinations according to the invention can, in commercial formulations and in the use forms prepared from these formulations, be present as a mixture with other active compounds, such as insecticides, attractants, sterilants, bactericides, acaricides, nematicides, fungicides, growth regulators or herbicides.

When using the active compound combinations according to the invention, the application rates can be varied within a relatively wide range, depending on the kind of application. In the treatment of parts of plants, the application rates of active compound combination are generally between 0.1 and 10 000 g/ha, preferably between 10 and 1000 g/ha. In the treatment of seeds, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5000 g/ha.

The active compound combinations can be used as such, in the form of concentrates or in the form of generally customary formulations, such as powders, granules, solutions, suspensions, emulsions or pastes.

The formulations mentioned can be prepared in a manner known per se, for example by mixing the active compounds with at least one solvent or diluent, emulsifier, dispersant and/or binder or fixative, water repellent, if desired desiccants and UV stabilizers, and, if desired, colorants and pigments and other processing auxiliaries.

The active compound combinations according to the invention are of superior fungicidal action. While the individual active compounds show weaknesses in their fungicidal action, the combinations show an action which exceeds a simple sum of actions.

A synergistic effect in the fungicides is always present when the fungicidal action of the active compound combinations exceeds the total of the action of the active compounds when applied individually.

The expected fungicidal action for a given combination of two active compounds can be calculated as follows, according to S. R Colby (“Calculating Synergistic and Antagonistic Responses of Herbicide Combinations”, Weeds 1967, 15, 20-22):

If

X is the efficacy when employing active compound A at an application rate of m g/ha,

Y is the efficacy when employing active compound B at an application rate of n g/ha and

E is the efficacy when employing active compounds A and B at application rates of m and n g/ha,

then

$$E = X + Y - \frac{X \times Y}{100}$$

Here, the efficacy is determined in %. 0% means an efficacy which corresponds to that of the control, whereas an efficacy of 100% means that no infection is observed.

If the actual fungicidal action exceeds the calculated value, the action of the combination is superadditive, i.e. a synergistic effect is present. In this case, the actually observed efficacy must exceed the value calculated using the above formula for the expected efficacy (E).

The present invention is illustrated by the following examples but not limited to these.

### PREPARATION EXAMPLES

### Preparation of 2-bromo-4-methyl-5-nitrobenzaldehyde

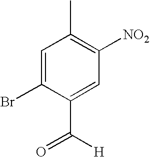

To a solution of 11.00° g (55.2° mmol) 2-bromo-4-methylbenzaldehyde in 65 ml sulfuric acid (95%) 11 mL of nitric acid (68%) is added dropwise at 5° C. The reaction temperature is kept below 15° C. The reaction mixture is stirred at 15° C. for 1 h and subsequently poured into icewater. After filtration and washing with water the solid residue is dried in vacuo. 13.00 g (74% GC-MS-purity, 39.4 mmol, 71% of theoretic yield) of 2-bromo-4-methyl-5-nitrobenzaldehyd (logp (HCOOH)=2.61) are obtained.

### Preparation of 1-bromo-2-(difluoromethyl)-5-methyl-4-nitrobenzene

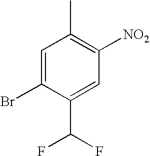

To a solution of 9.50 g (28.8 mmol, 74% GC-MS-purity) 2-bromo-4-methyl-5-nitrobenzaldehyde in 150 ml dichloromethan abs. 12.20 g diethylaminosulfurtrifluoride (75.7 mmol) is added dropwise at −30° C.

The reaction mixture is stirred for 2 h at −30° C. and warmed up overnight to room temperature. After quenching the reaction mixture with methanol 50 ml of water are added. The mixture is extracted three times with dichloromethane. The unified organic phases are dried over magnesium sulphate and concentrated in vacuo.

Column cromatography (cyclohexene/acetic acidethylester=10:1) yields 8.0 g (22.2 mmol, 74% GC-MS-purity, 77% theoretic yield) of 1-bromo-2-(difluormethyl)-5-methyl-4-nitrobenzene as a solid residue.

### Preparation of {3-[2-(difluoromethyl)-5-methyl-4-nitrophenoxy]propyl}(trimethyl)-silane

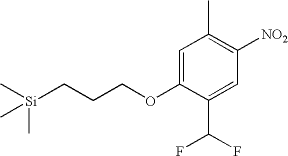

A suspension of 7.68 g (58 mmol) 3-(trimethylsilyl)propan-1-ol, 11.87 g (33 mmol, 74% GC-MS-purity) 1-bromo-2-(difluoromethyl)-5-methyl-4-nitrobenzene und 16.1 g (49.5 mmol) Cs₂CO₃ in 100 ml abs. toluene is stirred for 10 minutes under Argon atmosphere. Then 592.8 mg (2.64 mmol) palladium acetate and 984.9 mg (3.3 mmol) biphenyl-2-yl(di-tert-butyl)phosphine are added. The reaction mixture is stirred for 10 minutes at RT and subsequently for 12 h at 90° C. After cooling off the reaction mixture is filtered over Celite and washed with acetic acid ethylester. After evaporating the solvents in vacuo, column chromatography (cyclohexene/acetic acid ethylester) yields a first fraction of 4.8 g (68% LC-MS-purity) and a further fraction of 2.4 g (82% LC-MS-purity) of {3-[2-(difluoromethyl)-5-methyl-4-nitrophenoxy]propyl}(trimethyl)silane (LogP (HCOOH)=5.44).

### Preparation of 5-(difluoromethyl)-2-methyl-4-[3-(trimethylsilyl)propoxy]aniline

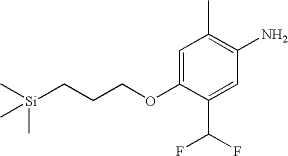

To a solution of 7.15 g {3-[2-(difluoromethyl)-5-methyl-4-nitrophenoxy]propyl}(trimethyl)silane in 100 ml abs. methanol 1 g Pd/C (10%) is added. The reaction mixture is treated with 1 bar hydrogen overnight. After filtering the mixture over Celtite and evaporating the solvent in vacuo, column chromatography (eluent: c-Hex/EE) yields 3.4 g (75% LC-MS-purity) of 5-(difluoromethyl)-2-methyl-4-[3-(trimethylsilyl)propoxy]anilin (LogP (HCOOH)=3.8).

### Preparation of N′-{5-(difluoromethyl)-2-methyl-4-[3-(trimethylsilyl)propoxy]phenyl}-N-ethyl-N-methylimidoformamide

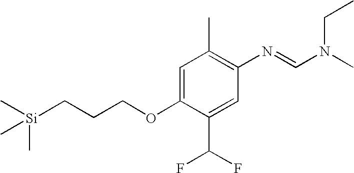

3.5 g (75% LC-MS-purity) of 5-(difluoromethyl)-2-methyl-4-[3-(trimethylsilyl)propoxy]aniline are solved in 58 ml toluene abs. and treated with 6.49 g N-(dimethoxymethyl)-N-methylethanamine. The reaction mixture is stirred overnight at 60° C. After evaporating the solvent in vacuo, column chromatography (gradient: cyclohexae/acetic acid ethylester; Alox) yields 3.4 g (100% LC-MS-purity) N′-{5-(difluoromethyl)-2-methyl-4-[3-(trimethylsilyl)propoxy]phenyl}-N-ethyl-N-methylimidoformamide (LogP (HCOOH)=2.81).

### BIOLOGICAL EXAMPLES

### Example A

### Botrytis Test (Beans)/Protective

Solvent: 24.5 parts by weight of acetone
24.5 parts by weight of dimethylacetamide

Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound. After the spray coating has dried on, 2 small pieces of agar covered with growth of Botrytis cinerea are placed on each leaf. The inoculated plants are placed in a darkened chamber at 20° C. and a relative atmospheric humidity of 100%.

2 days after the inoculation, the size of the lesions on the leaves is evaluated. 0% means an efficacy which corresponds to that of the control, while an efficacy of 100% means that no disease is observed.

The table below clearly shows that the observed activity of the active compound combination according to the invention is greater than the calculated activity, i.e. a synergistic effect is present.

TABLE 4-1
Botrytis test (beans)/protective

| | Rate of application | |
|---|---|---|
| Active compound | of active compound | Efficacy |
| Known: in ppm | in % | |
| 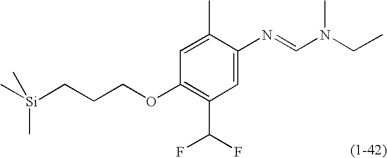 | 100 10 | 29 0 |
| 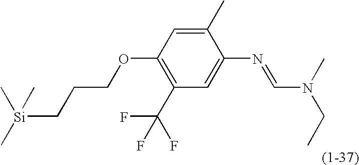 | 100 10 | 23 0 |
| 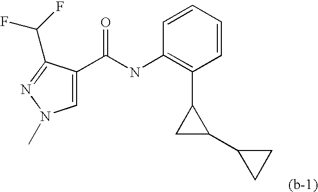 | 100 | 38 |
| 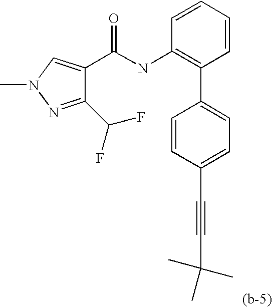 | 10 | 80 |

TABLE A-2
Botrytis test (beans)/protective
Inventive Compound combination:

| | | Ratio of the | Rate of application of | | Actual | Expected value, calculated |
|---|---|---|---|---|---|---|
| | | mixture | active compound in ppm | | efficacy | using Colby's formula |
| (1-42) + (b-1) | } | 1:1 | 100 + 100 | } | 78 | 56 |
| (1-37) + (b-1) | } | 1:1 | 100 + 100 | } | 78 | 52 |
| (1-42) + (b-5) | } | 1:1 | 10 + 10 | } | 89 | 80 |
| (1-42) + (b-5) | } | 1:1 | 10 + 10 | } | 93 | 80 |

### Example B

### Leptosphaeria nodorum Test (Wheat)/Protective

Solvent: 50 parts by weight of n,n-dimethylacetamid

Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test for protective activity, young plants are sprayed with a preparation of active compound or active compound combination at the stated rate of application. After the spray coating has been dried, the plants are sprayed with a spore suspension of Leptosphaeria nodorum. The plants remain for 48 hours in an incubation cabinet at 20° C. and a relative atmospheric humidity of 100%.

The plants are placed in a greenhouse at a temperature of approximately 15° C. and a relative atmospheric humidity of approximately 80%.

The test is evaluated 10 days after the inoculation. 0% means an efficacy which corresponds to that of the control, while an efficacy of 100% means that no disease is observed.

TABLE B
Leptosphaeria nodorum test (wheat)/protective

| | |
|---|---|
| Rate of application of | Efficacy |
| active compound | in % |

| Active compound | in ppm | a.e.* | e.v.** |
|---|---|---|---|
| (1-37) | 125 | 92 | |
| (b-7) | 125 | 67 | |
| (b-5) | 125 | 67 | |
| (1-37) + (b-7) | 125 + 125 | 100 | 97 |
| (1-37) + (b-5) | 125 + 125 | 100 | 97 |

*a.e. = actual efficacy
**e.v. = expected value, calculated using Colby's formula

### Example C

### Septoria tritici Test (Wheat)/Protective

Solvent: 50 parts by weight of n,n-dimethylacetamid

Emulsifier: 1 part by weight of alkylaryl polyglycol ether

To produce a suitable preparation of active compound, 1 part by weight of active compound or active compound combination is mixed with the stated amounts of solvent and emulsifier, and the concentrate is diluted with water to the desired concentration.

To test the protective activity, young plants are sprayed with a preparation of active compound or active compound combination at the stated rate of application. After the spray coating has been dried, the plants are sprayed with a spore suspension of Septoria tritici. The plants remain for 48 hours at 20° C. and then 60 hours at 15° C. in an incubation cabinet at a relative atmospheric humidity of 100%.

The plants are placed in a greenhouse at a temperature of approximately 15° C. and a relative atmospheric humidity of approximately 80%.

The test is evaluated 20 days after inoculation. 0% means an efficacy which corresponds to that of the control, while an efficacy of 100% means that no disease is observed.

TABLE C
Septoria tritici test (wheat)/protective

| | |
|---|---|
| Rate of application of | Efficacy |
| active compound | in % |

| Active compound | in ppm | a.e.* | e.v.** |
|---|---|---|---|
| (1-37) | 125 | 30 | |
| (b-1) | 125 | 10 | |
| (b-17) | 125 | 30 | |
| (b-18) | 125 | 90 | |
| (b-19) | 125 | 30 | |
| (1-37) + (b-1) | 125 + 125 | 70 | 37 |
| (1-37) + (b-17) | 125 + 125 | 90 | 51 |
| (1-37) + (b-18) | 125 + 125 | 100 | 93 |
| (1-37) + (b-19) | 125 + 125 | 70 | 51 |

*a.e. = actual efficacy
**e.v. = expected value, calculated using Colby's formula

1. A fungicidal mixture comprising
(a) at least one compound selected from the phenylamidines of Formula I, N-oxides, and agriculturally suitable salts thereof 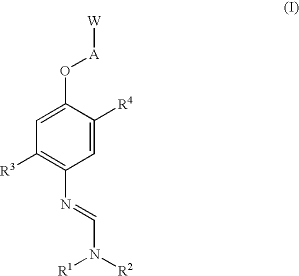
R¹ is C₁-C₂ alkyl;
R² is C₁-C₃ alkyl or cyclopropyl;
R³ is hydrogen, C₁-C₂ alkyl or halogen;
R⁴ is C₁-C₂ alkyl, C₁-C₂ haloalkyl, methoxy, halomethoxy, C₁-C₂ alkylthio, C₁-C₂ alkylsulfinyl, C₁-C₂ alkylsulfonyl or halogen;
A is C₃ alkylene, optionally substituted with one or two methyl;
W is CR⁵R⁶R₇ or SiR⁸R⁹R¹⁰; and
R₅ is hydrogen or C₁-C₃ alkyl optionally substituted with halogen; and
each R⁶, R⁷, R⁸, R⁹ and R¹⁰ is independently C₁-C₃ alkyl optionally substituted with halogen; and
(b) at least one compound selected from the group consisting of compounds (b-1) to (b-20); or agriculturally suitable salts thereof

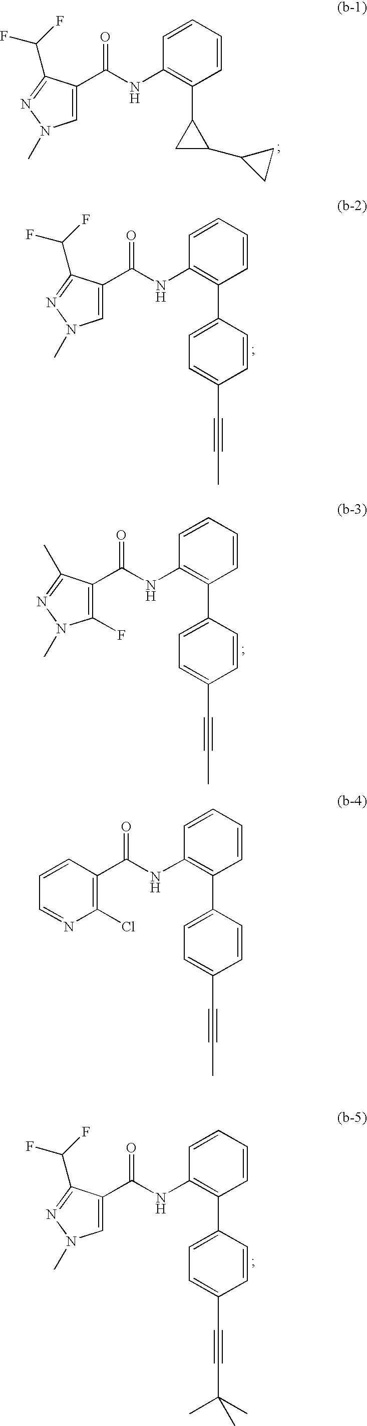

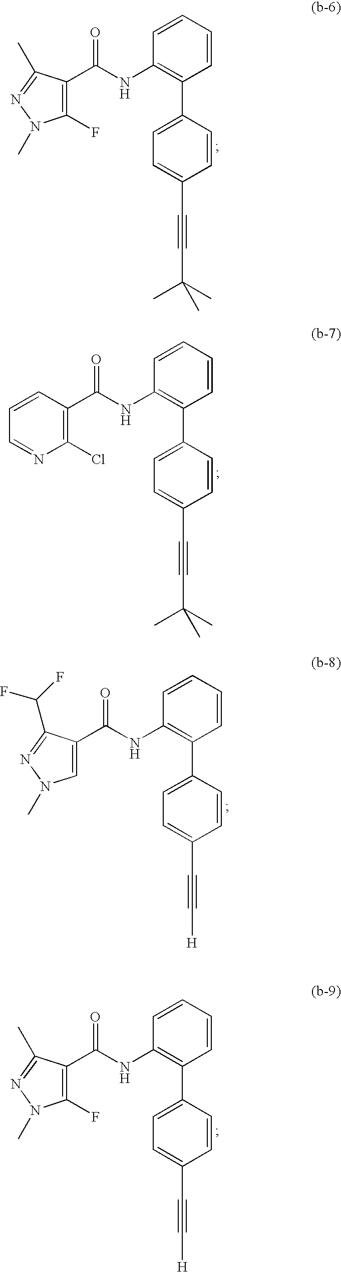

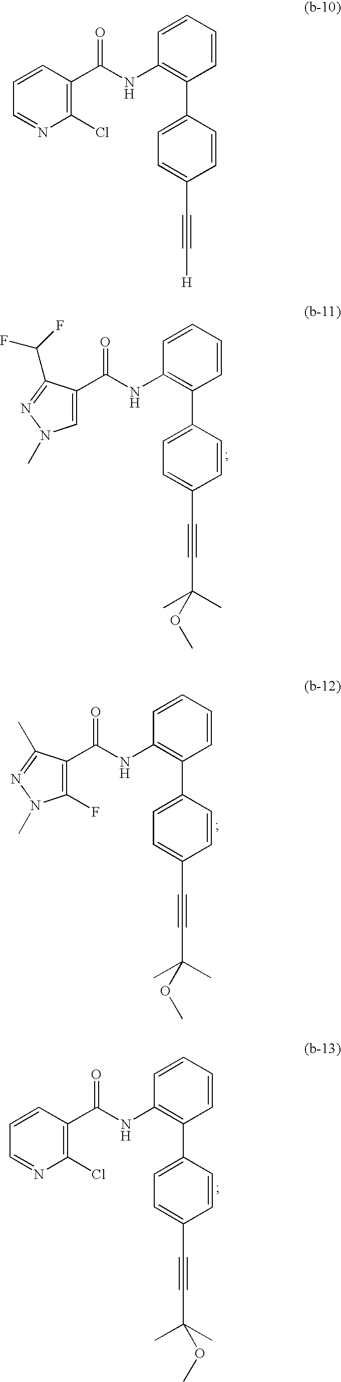

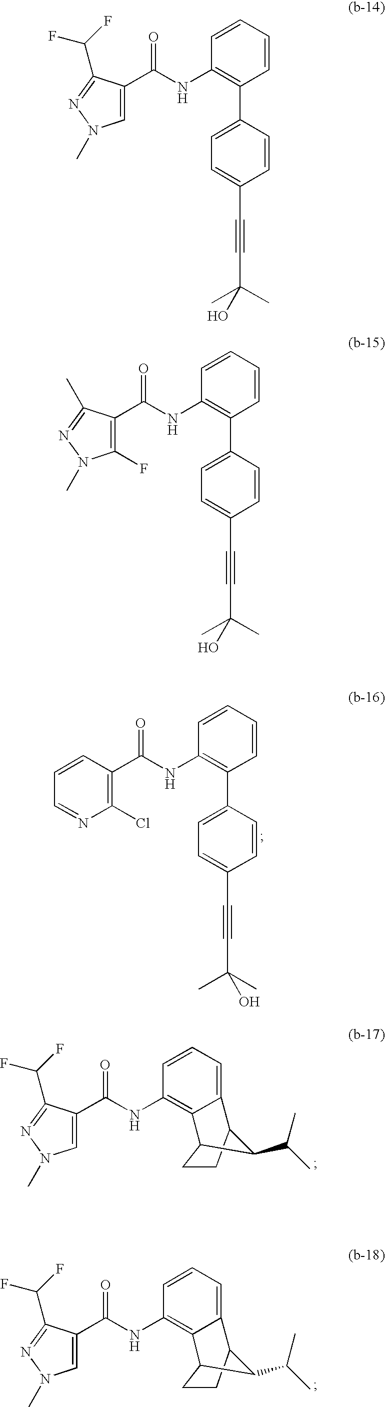

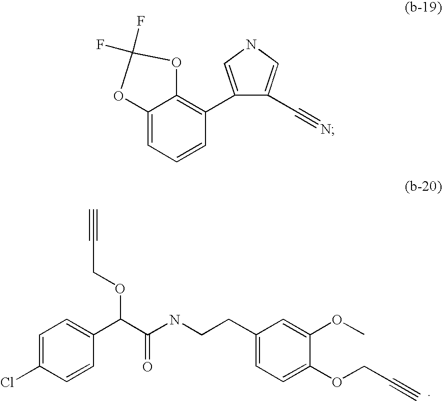

2. A mixture of claim 1 wherein for component (a) R¹ is methyl or ethyl and R² is methyl, ethyl or cyclopropyl.

3. A fungicidal composition comprising a fungicidally effective amount of the mixture of claim 1 and at least one additional component selected from the group consisting of surfactants, solid diluents and liquid diluents.

4. A composition of claim 3 wherein the weight ratio of component (b) to component (a) is from 100:1 to 1:100.

5. A method for controlling plant diseases caused by fungal plant pathogens comprising applying to the plant or portion thereof, or to the plant seed or seedling, a fungicidally effective amount of the mixture of claim 1

6. A fungicidal composition comprising a fungicidally effective amount of the mixture of claim 2 and at least one additional component selected from the group consisting of surfactants, solid diluents and liquid diluents.

7. A method for controlling plant diseases caused by fungal plant pathogens comprising applying to the plant or portion thereof, or to the plant seed or seedling, a fungicidally effective amount of the mixture of claim 2.

8. A method for controlling plant diseases caused by fungal plant pathogens comprising applying to the plant or portion thereof, or to the plant seed or seedling, a fungicidally effective amount of the composition of claim 3.

9. A method for controlling plant diseases caused by fungal plant pathogens comprising applying to the plant or portion thereof, or to the plant seed or seedling, a fungicidally effective amount of the composition claim 4.
